(19) United States
(12) Patent Application Publication
(10) Pub. No.: US 2024/0326142 A1
(43) Pub. Date: Oct. 3, 2024

(54) GROUND TAMPER ACCESSORY FOR RECIPROCATING SAW

(71) Applicant: Wayne Michael Buchanan, Valleyview (CA)

(72) Inventor: Wayne Michael Buchanan, Valleyview (CA)

(21) Appl. No.: 18/194,705

(22) Filed: Apr. 3, 2023

(51) Int. Cl. B23D 49/10

(52) U.S. Cl. CPC B23D 49/105

(57) ABSTRACT

A tamping apparatus that is configured to be operably coupled to a reciprocating saw in order to be employed to compact material. The present invention includes a stem member having a first end and a second end wherein the first end includes a tang configured to be operably coupled to a chuck of a reciprocating saw. A plate member is secured to the second end of the stem member and is planar in manner. The plate member includes a rolled front edge and in a preferred embodiment is rectangular in shape. The tamping apparatus further includes an expansion plate member that is configured to be releasably secured to the plate member and has a surface area that is larger. An impact force reduction member is integrally formed with the stem member and provides reduction of impact force transferred to the reciprocating saw during use of the tamping apparatus.

### FIELD OF THE INVENTION

The present invention relates generally to portable tools, more specifically but not by way of limitation, an accessory for a handheld reciprocating saw wherein the present invention includes elements that are formed to execute tamping of the ground to provide leveling and compaction thereof.

### BACKGROUND

As known in the art, there are a multitude of power tools that are designed to assist in the execution of a task. These wide range of tools are often task specific. By way of example but not limitation, handheld drills are employed for drilling and driving screws. Larger tools such as landscaping tools are also well known in the art. One common tool is a ground tamper. Ground tampers are available as manual devices that include a tamping plate and a handle or automated tampers are available that include a weighted engine chassis that powers a tamping plate. Both of the aforementioned are utilized for compacting and level material such as but not limited to sand or aggregate.

While the aforementioned devices execute their intended tasks well, there are drawbacks to these conventional devices. One drawback is the size of the conventional devices inhibit an ability to access in certain areas such as but not limited to smaller areas around fence posts. Another deficiency for the conventional tamping devices is they cannot compact material in retaining walls and other smaller spaces.

Accordingly, there is a need for a tamping device that is operable to provide tamping and compacting of material wherein the present invention can be utilized in tight areas such as but not limited areas around fence posts and retaining walls.

### SUMMARY OF THE INVENTION

It is the object of the present invention to provide a tamping assembly configured to be secured to a handheld reciprocating saw wherein the present invention includes a stem member wherein the stem member includes a first end and a second end.

Another object of the present invention is to provide a ground tamping device operable to provide tamping and compacting of material wherein the present invention includes a plate member secured to the second end of the stem member.

A further object of the present invention is to provide a tamping assembly configured to be secured to a handheld reciprocating saw wherein the plate member is planar in manner having an upper surface and a lower surface.

Yet a further object of the present invention is to provide a ground tamping device operable to provide tamping and compacting of material wherein one embodiment of the stem member includes an impact force reduction member.

Still another object of the present invention is to provide a tamping assembly configured to be secured to a handheld reciprocating saw wherein the present invention includes at least one expansion plate member.

An additional object of the present invention is to provide a ground tamping device operable to provide tamping and compacting of material wherein the expansion plate member includes an upper surface and a lower surface and is planar in manner.

Yet a further object of the present invention is to provide a tamping assembly configured to be secured to a handheld reciprocating saw wherein the upper surface of the expansion plate member includes locking members formed thereon.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

FIG. 2 is perspective view of the present invention coupled to a reciprocating saw; and

FIG. 3 is a perspective view of an alternative embodiment of the present invention; and

FIG. 4 is a top view of an expansion plate member of the present invention.

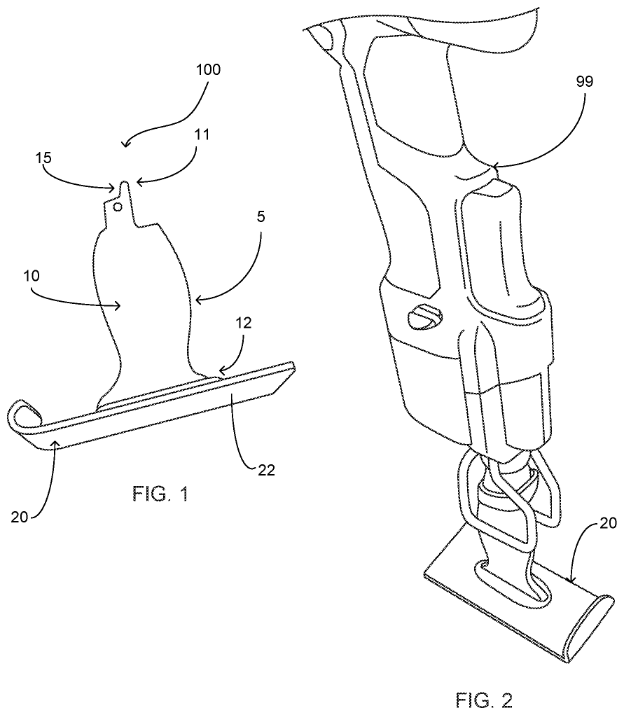

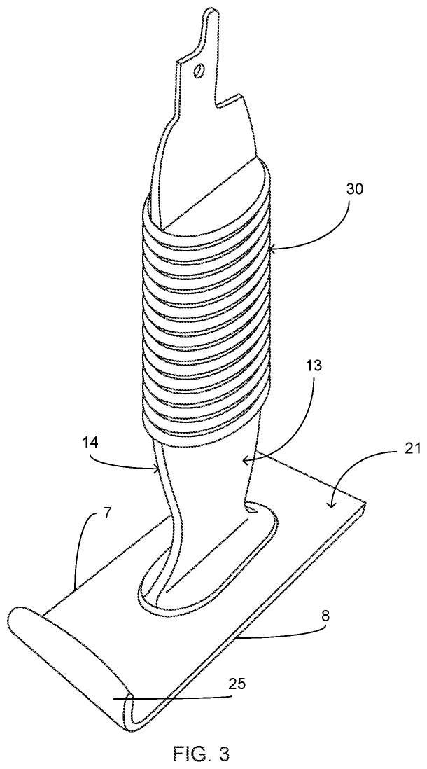

### DETAILED DESCRIPTION

Referring now to the drawings submitted herewith, wherein various elements depicted therein are not necessarily drawn to scale and wherein through the views and figures like elements are referenced with identical reference numerals, there is illustrated a tamping apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the tamping apparatus 100 is manufactured from a rigid durable material such as but not limited to metal. The tamping apparatus 100 includes a body 5 having a stem member 10 and plate member 20. Stem member 10 includes a first end 11 and a second end 12. The stem member 10 is planar in manner having a first side 13 and second side 14. Located proximate the first end 11 is tang member 15 wherein tang member 15 is configured to be operably coupled to a chuck of a conventional reciprocating saw. It is contemplated within the scope of the present invention that the first end 11 could be configured in alternate manners in order to operably couple to a chuck of a reciprocating saw.

Secured to the second end 12 of the stem member 10 is plate member 20. Plate member 20 is secured to the stem member 10 utilizing suitable durable techniques. The plate member 20 is planar in manner having an upper surface 21 and lower surface 22. While the plate member 20 is illustrated herein as being rectangular in shape, it is contemplated within the scope of the present invention that the plate member 20 could be formed in alternate shapes. The plate member 20 includes forward edge 25 that is rolled in form. The shape of the forward edge 25 inhibits snagging of the plate member 20 as the tamping apparatus 100 is traversed across an area during compacting thereof.

Referring in particular to FIG. 3 submitted herewith, the impact force reduction member 30 is illustrated therein. The impact force reduction member 30 is integrally formed with the stem member 10 located proximate the midpoint thereof. The impact force reduction member 30 provides absorption of the impact force from the plate member 20 during operation of the tamping apparatus 100 so as to inhibit transfer of the force to a user holding the reciprocating saw 99. It should be understood within the scope of the present invention that the impact force reduction member 30 could employ elements such as but not limited to springs or hydraulics in order to achieve the desired objective discussed herein.

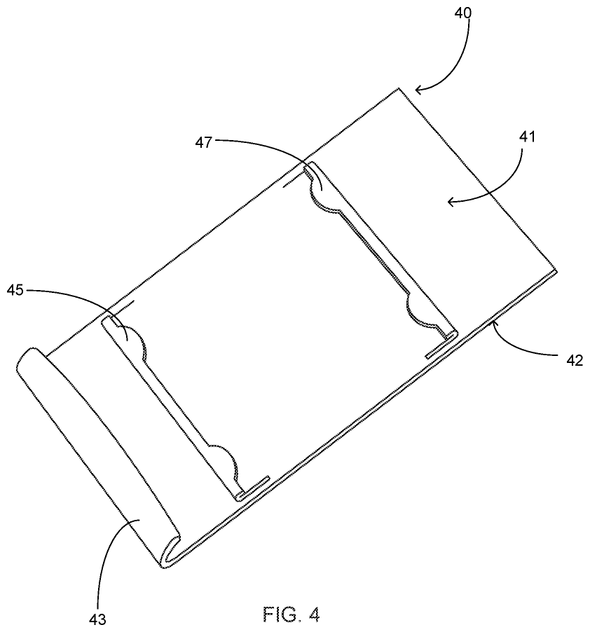

Now referring in particular to FIG. 4, the expansion plate member 40 is illustrated therein. The expansion plate member 40 is releasably coupled to the plate member 20 and functions to increase the surface area that the tamping apparatus 100 can compact. The expansion plate member 40 includes an upper surface 41 and lower surface 42. The front edge 43 of the expansion plate member 40 is rolled in form so as to function similarly to forward edge 25. The expansion plate member 40 has a surface area that is larger than that of the plate member 20 so as to be employed by a user of the tamping apparatus 100 for larger areas of ground. Formed on the upper surface 41 of the expansion plate member 40 are keepers 45,47. Keepers 45, 47 extend upward from the expansion plate member 40 and function to releasably secure the plate member 20 to the expansion plate member 40. The keepers 45,47 engage the lateral edges 7,8 of the plate member 20 and releasably secure thereto so as to maintain operable coupling of the expansion plate member 40. It is contemplated within the scope of the present invention that the expansion plate member 40 could be releasably secured to the plate member 20 utilizing numerous alternate techniques such as but not limited to mechanical fasteners.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A tamping apparatus configured to be operably coupled to a reciprocating saw wherein the tamping apparatus comprises:
a body, said body having a stem member, said stem member having a first end and a second end, said stem member being rigid, said first end of said stem member configured to operably couple to a chuck of the reciprocating saw, said body further having a plate member, said plate member being secured to said second end of said stem member, said stem member being perpendicular to said plate member and extending upward from an upper surface thereof, said plate member being planar in manner; and
wherein said plate member is configured to have a lower surface thereof engage material for compacting thereof during operation of the reciprocating saw.

2. The tamping apparatus configured to be operably coupled to the reciprocating saw as recited in claim 1, wherein said plate member further includes a front edge, said front edge being rolled in form.

3. The tamping apparatus configured to be operably coupled to the reciprocating saw as recited in claim 2, and further including an expansion plate member, said expansion plate member being planar in manner having an upper surface and a lower surface, said expansion plate member configured to be releasably secured to the plate member.

4. The tamping apparatus configured to be operably coupled to the reciprocating saw as recited in claim 3, wherein said expansion plate member has a surface area that is greater than a surface are of said plate member.

5. The tamping apparatus configured to be operably coupled to the reciprocating saw as recited in claim 4, wherein said expansion plate member further includes keepers formed on the upper surface thereof, said keepers configured to releasably secure said expansion plate member to said plate member.

6. The tamping apparatus configured to be operably coupled to the reciprocating saw as recited in claim 5, and further including an impact force reduction member, said impact force reduction member being integrally formed with said stem member, said impact force reduction member operable to reduce impact force transferred to the reciprocating saw.
